(19) United States
(12) Patent Application Publication
(10) Pub. No.: US 2014/0004218 A1
(43) Pub. Date: Jan. 2, 2014

(54) Mold-Tool System Including Actuation System

(71) Applicant: Brian Esser, Colchester, VT (US)

(72) Inventor: Brian Esser, Colchester, VT (US)

(73) Assignee: HUSKY INJECTION MOLDING SYSTMES LTD., Bolton, ON (CA)

(21) Appl. No.: 14/004,927

(22) PCT Filed: Mar. 9, 2012
(86) PCT No.: PCT/US12/28387

§ 371 Date: Sep. 13, 2013

(30) Foreign Application Priority Data
Mar. 15, 2011 (US) 61452773

(51) Int. Cl. B29C 33/00

(52) U.S. Cl. CPC B29C 33/0083
USPC 425/162

(57) ABSTRACT

A mold-tool system (100), comprising: an actuation system (200), including: an electric motor (202) being configured to convert electrical energy to mechanical rotational energy; a torque-amplifying device (204) being coupled to the electric motor (202), and being configured to provide a speed-torque varying component of the mechanical rotational energy associated with the electric motor (202); and a conversion assembly (206) being coupled with the torque-amplifying device (204), the conversion assembly (206) being configured to convert rotational motion of the torque-amplifying device (204) to a linear motion.

### TECHNICAL FIELD

An aspect generally relates to (but is not limited to) molding systems, including (but not limited to) a mold-tool system.

### SUMMARY

The inventor has researched a problem associated with known molding systems that inadvertently manufacture bad-quality molded articles or parts. After much study, the inventor believes he has arrived at an understanding of the problem and its solution, which are stated below, and the inventor believes that this understanding may not be known to the public.

Electrical actuation methods have a certain energy density that is they can only provide so much force and speed. An increase in speed results in a corresponding decrease in force. Fixed systems must be set to deliver a compromise of maximum force and speed, resulting in a system that is optimized for neither attribute.

By incorporating a system which adjusts the force-speed output of the electrical actuator (either automatically or through external control), the valve stem can move as fast as possible with the given force requirements. This will results in a smaller actuator for a given set of force-speed requirements and perhaps enable solutions that are otherwise not feasible. In addition, a single type of system could be used on a wide variety of applications as the system compensates for increased force requirements and thus would work well for both low force high speed applications as well as slower, higher force applications.

According to one aspect, there is provided a mold-tool system (100), comprising: an actuation system (200), including: an electric motor (202) being configured to convert electrical energy to mechanical rotational energy; a torque-amplifying device (204) being coupled to the electric motor (202), and being configured to provide a speed-torque varying component of the mechanical rotational energy associated with the electric motor (202); and a conversion assembly (206) being coupled with the torque-amplifying device (204), the conversion assembly (206) being configured to convert rotational motion of the torque-amplifying device (204) to a linear motion.

Other aspects and features of the non-limiting embodiments will now become apparent to those skilled in the art upon review of the following detailed description of the non-limiting embodiments with the accompanying drawings.

### DETAILED DESCRIPTION OF THE DRAWINGS

The non-limiting embodiments will be more fully appreciated by reference to the following detailed description of the non-limiting embodiments when taken in conjunction with the accompanying drawings, in which:

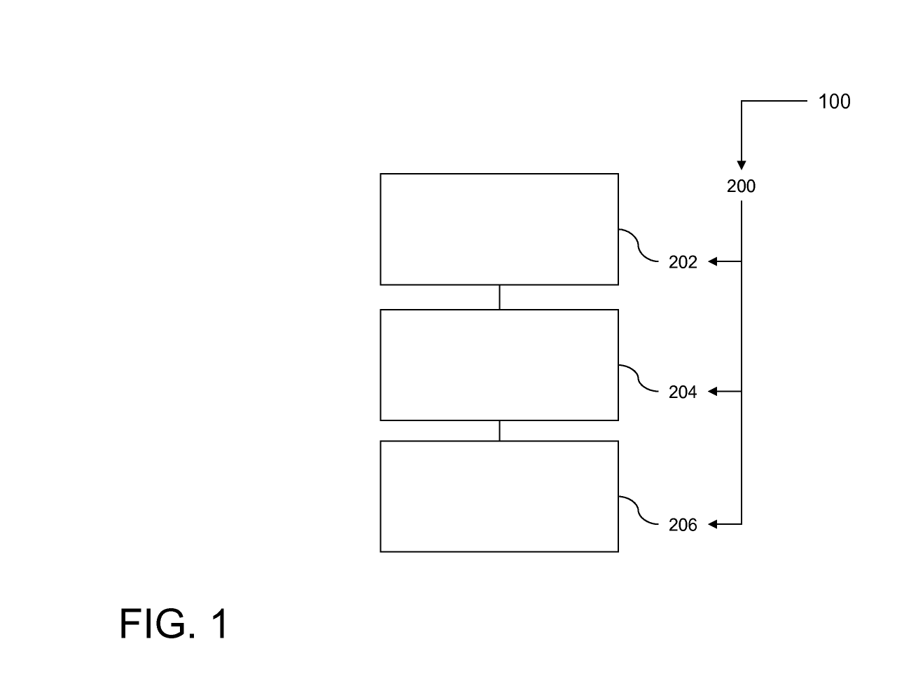

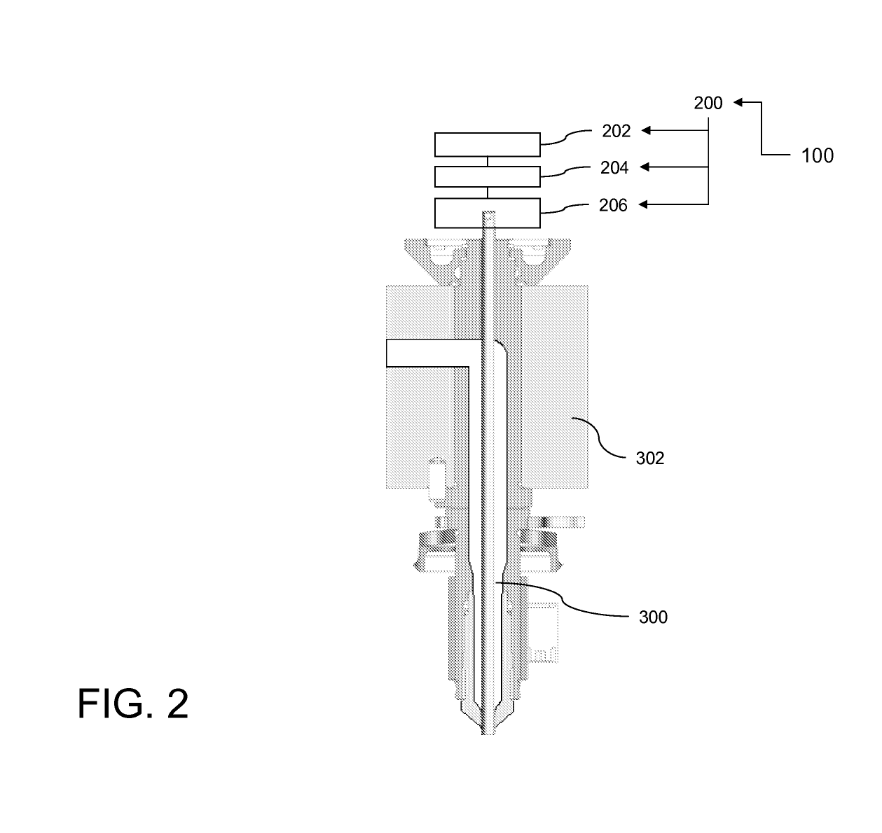

FIGS. 1 and 2 depict schematic representations of a mold-tool system (100).

The drawings are not necessarily to scale and may be illustrated by phantom lines, diagrammatic representations and fragmentary views. In certain instances, details not necessary for an understanding of the embodiments (and/or details that render other details difficult to perceive) may have been omitted.

### DETAILED DESCRIPTION OF THE NON-LIMITING EMBODIMENT(S)

FIGS. 1 and 2 depict schematic representations of a mold-tool system (100). It will be appreciated that for the purposes of this document, the phrase “includes (but is not limited to)” is equivalent to the word “comprising.” The word “comprising” is a transitional phrase or word that links the preamble of a patent claim to the specific elements set forth in the claim that define what the invention itself actually is. The transitional phrase acts as a limitation on the claim, indicating whether a similar device, method, or composition infringes the patent if the accused device (etc) contains more or fewer elements than the claim in the patent. The word “comprising” is to be treated as an open transition, which is the broadest form of transition, as it does not limit the preamble to whatever elements are identified in the claim.

The definition of the mold-tool system (100) is as follows: (i) a system that may be positioned and/or may be used in an envelope defined by a platen system (not depicted) of the molding system (not depicted), such as an injection-molding system for example. The platen system may include a stationary platen and a movable platen that is moveable relative to the stationary platen, and/or (ii) a system that may be positioned and/or may be used in outside of an envelope defined by the platen system of the molding system.

Referring to FIG. 1, the mold-tool system (100) may include (and is not limited to) an actuation system (200). The actuation system (200) may include (and is not limited to): (i) an electric motor (202), (ii) a torque-amplifying device (204), and (iii) a conversion assembly (206). The electric motor (202) may be configured to convert electrical energy to mechanical rotational energy. The torque-amplifying device (204) may be coupled to the electric motor (202). The torque-amplifying device (204) may be configured to provide a speed-torque varying component of the mechanical rotational energy associated with the electric motor (202). The conversion assembly (206) may be coupled with the torque-amplifying device (204). The conversion assembly (206) may be configured to convert rotational motion of the torque-amplifying device (204) to a linear motion.

Referring now to FIG. 2, the mold-tool system (100) may be adapted such that the conversion assembly (206) may be connected to valve stem (300) of a runner assembly (302), and the conversion assembly (206) may be configured to linearly move the valve stem (300).

It will be appreciated that the runner assembly (302) may have the mold-tool system (100). It may also be appreciated that the molding system may have the mold-tool system (100). Examples of the electric motor (202) may include and is not limited to: (i) a direct current motor, (ii) a permanent magnet motor, (iii) a universal motor, (iv) an alternating current (AC) motor. Examples of the torque-amplifying device (204) may include (and is not limited to): (i) a gearbox assembly, (ii) a planetary-gear reduction assembly, (iii) a viscous-torque converter, (iv) a continuously-variable transmission (CVT). Examples of the continuously-variable transmission (CVT) may include (and is not limited to): (i) a friction-drive assembly, (ii) a positive-drive assembly, (iii) a chain assembly, a belt assembly, a gear assembly, a toroidal-based assembly, and a roller-based assembly. Examples of the rotational to linear motion conversion assembly (206) may include (and is not limited to): (i) a ball screw actuator, (ii) a lead screw actuator, (iii) a rack and pinion assembly, (iv) a worm drive assembly.

The actuation system (200) may be configured to adjust a force-speed output of the electric motor (202) to provide an optimized output. This arrangement may be accomplished through numerous assemblies including but not limited to fluid couplings, planetary gear sets, clutches, etc.

The actuation system (200) may be configured to adjust a force-speed output automatically, or may include an actuation means. The actuation system (200) may move as fast as possible during an initial closing of the valve stem (300), then slow down with a corresponding increase of output force/torque as the valve stem (300) becomes more difficult to move as the valve stem (300) displaces more or higher pressure resin. For the case of opening the valve stem (300), the valve stem (300) may be moved very quickly as the force requirements for this case may be correspondingly low.

A fluid coupling may act similar to a torque converter in an automatic automotive transmission. When a resistance (force) is low, the output may match a speed of the input. When the force requirements increase, the fluid coupling may allow slippage of the input relative to the output, but may provide an increase in output torque through the fluid shear forces acting on the output. This arrangement may also prevent damage to the electric motor (202) for the case of excessive force as the fluid coupling may allow the actuation system (200) to continue to move without requiring any movement of the output.

A planetary assembly may rely on a planetary gear set, which may operate in a direct drive mode, a planetary-reduction mode, or a combination of the two modes to provide the required motion. For the case where the force requirements are low, the input speed may match the output speed and the planetary drive may rotate as well. When the force requirements increased, the planetary drive may slow its spinning, resulting in a torque amplification as the internal gears begin to spin, so that the actuation system (200), may self compensate to deliver the maximum speed for the given force requirements.

Other methods to create this force compensating valve actuation may include a continuously-variable transmission (CVT), in which the force automatically increases as the rotational speed decreases (and vice-versa). Another example may include an automatic transmission style actuation where the speed and load on the output shaft determine the gear set used for that particular portion of the stroke. Other methods to accomplish this force-speed compensation may include slipper clutches, or combinations of the above examples. In addition, other power transmission devices may be used in conjunction with the force compensating device to provide the required motion, such as worm drives, rack and pinions, etc.

As mentioned above, the actuation system (200) may automatically compensate for the requirements (similar to that of a differential or torque converter), or have active actuation. Active actuation may use a variety of actuation assemblies, such as electrical engagement actuators to change parameters (i.e., engage or disengage direct drive versus reduced speed torque amplification), active fluid coupling using magneto-rheological fluids, or other means. Feedback of the position of valve stem (300) may also be used to control the position of the valve stem (300) as a function of time to provide profiled actuation, within the capabilities of the system's speed-force properties. While the most attractive implementation of the actuation system (200) uses an electrical actuator to create the motion, the actuation system (200) may be used on or with a valve stem (300) that may be pneumatically or hydraulically actuated.

It will be appreciated that the assemblies and modules described above may be connected with each other as may be required to perform desired functions and tasks that are within the scope of persons of skill in the art to make such combinations and permutations without having to describe each and every one of them in explicit terms. There is no particular assembly, components, or software code that is superior to any of the equivalents available to the art. There is no particular mode of practicing the inventions and/or examples of the invention that is superior to others, so long as the functions may be performed. It is believed that all the crucial aspects of the invention have been provided in this document. It is understood that the scope of the present invention is limited to the scope provided by the independent claim(s), and it is also understood that the scope of the present invention is not limited to: (i) the dependent claims, (ii) the detailed description of the non-limiting embodiments, (iii) the summary, (iv) the abstract, and/or (v) description provided outside of this document (that is, outside of the instant application as filed, as prosecuted, and/or as granted). It is understood, for the purposes of this document, the phrase “includes (and is not limited to)” is equivalent to the word “comprising.” It is noted that the foregoing has outlined the non-limiting embodiments (examples). The description is made for particular non-limiting embodiments (examples). It is understood that the non-limiting embodiments are merely illustrative as examples.

What is claimed is:

1. A mold-tool system (100), comprising:
a movable element (299) being configured to move linearly; and
an actuation system (200) being connected to the movable element (299) the actuation system (200) being configured to:
(i) convert electrical energy to mechanical rotational energy;
(ii) provide a speed-torque varying component of the mechanical rotational energy; and
(iii) convert rotational motion associated with the speed-torque varying component to a linear motion.

2. The mold-tool system (100) of claim 1, wherein:
actuation system (200) includes:
an electric motor (202) being configured to convert electrical energy to mechanical rotational energy;
a torque-amplifying device (204) being coupled to the electric motor (202), and being configured to provide a speed-torque varying component of the mechanical rotational energy associated with the electric motor (202); and
a conversion assembly (206) being coupled with the torque-amplifying device (204), the conversion assembly (206) being configured to convert rotational motion of the torque-amplifying device (204) to a linear motion.

2. The mold-tool system (100) of claim 1, wherein:
the conversion assembly (206) is connected to valve stem (300) of a runner assembly (302), the conversion assembly (206) is configured to linearly move the valve stem (300).

3. A runner assembly (302) having the mold-tool system (100) of claim 1.

4. A molding system having the mold-tool system (100) of any preceding claim.
